(19) United States
(12) Patent Application Publication
(10) Pub. No.: US 2017/0093652 A1
(43) Pub. Date: Mar. 30, 2017

(54) VISUALIZATION HYPERTEXT

(71) Applicant: Microsoft Technology Licensing, LLC, Redmond, WA (US)

(72) Inventors: Kevin Blasko, Redmond, WA (US); Ketan Ghelani, Redmond, WA (US); Patrick Tseng, Kirkland, WA (US); Zhuming Pan, Sammamish, WA (US); Haiying Xu, Redmond, WA (US); Divya Jayaraman, Redmond, WA (US); Huan He, Bellevue, WA (US); Andrew Bragdon, San Francisco, CA (US)

(21) Appl. No.: 14/867,050

(22) Filed: Sep. 28, 2015

(51) Int. Cl. H04L 12/26; G06F 17/22; G06F 17/30; H04L 29/08

(52) U.S. Cl. CPC H04L 43/045; H04L 67/06; H04L 67/02; G06F 17/2235; G06F 17/30867

(57) ABSTRACT

A data visualization metrics explorer can be provided using JSON and hypertext. When an element of a grid row is selected, a new metrics explorer blade can be opened. A filter can be applied so that only information associated with the selected element is presented. Additional filters may also be applied to the data that is displayed. Progressive, iterative filtering can occur. The links between blades can be specified using JSON and hypertext. Multi-linking and re-use of individual JSON files can be performed by linking the JSON files together into a web. The web of visualization can be used to construct a web of visualization actions enabling data visualization exploration.

### BACKGROUND

Hypertext is information (such as text, tables, images, etc.) which is displayed on a computing device. Hypertext includes references, called hyperlinks, to other information. Hyperlinks enable web pages to be connected to other web pages. Web pages are often written in Hypertext Markup Language (HTML). In the early days of the Internet, most websites were based on complete HTML pages. Each user action loaded a complete page from the server. Consequently, page content disappeared and then reappeared, making for a less-than-optimal user experience. When something changed on a page, all of the content was re-sent, even when only some of the information had changed, making for inefficiencies in processing. Later advances enabled content to be loaded or fetched asynchronously using background HTTP requests.

A number of web technologies are now available to implement a web application that communicates with a server in the background without affecting the way the page is displayed to the user. In recent times HTML (or XHTML) and CSS has been used to control the presentation of content to the user, the Document Object Model (DOM) has been used for dynamic display of and interaction with data, XML has been used for exchanging data, XSLT has been used for manipulation of the data and an XMLHttpRequest object has been used for asynchronous communication between browser and server. Even more recently, JavaScript Object Notation (JSON) has been used as an alternative format for data exchange.

JSON (JavaScript Object Notation) uses human-readable text to transmit data objects comprising attribute-value pairs. JSON provides a means of stateful, real-time server-to-browser communication without the use of browser plugins such as Flash or Java applets. Standard browser capabilities are used. An abstraction layer is provided so that stateful web applications having a persistent duplex connection to a web server can be created by holding the two HTTP connections open and recycling them before standard browser time-outs if no further data were exchanged. Information can be passed into the user browsers' visual field using frames, without refreshing a Web application's visual context, using an object-based messaging format.

JSON is a language-independent data format. Code for parsing and generating JSON data is readily available for a large variety of programming languages. JSON-formatted data can be retrieved from several different web servers using an API such as but not limited to Open API. Open API is an API that one service exposes for another to consume (clients can also consume it, but where Open API is used, people are typically taking about Service 2 Service). An example would the Facebook Social Graph API which allows developers to consume information from Facebook through a neatly packaged API rather than needing to resort to (potentially TOS (terms of service) breaking) methods like screen scraping.

### SUMMARY

A data visualization metrics explorer can be provided using JavaScript Object Notation (JSON) and hypertext. When an element of a grid row is selected, a new metrics explorer blade (visualization) can be opened. A filter can be applied so that only information associated with the selected element is presented. Additional filters may also be applied to the data that is displayed. Progressive, iterative filtering can occur. The links between blades can be specified using a data format such as but not limited to JSON and hypertext. The JSON file, etc. can define the content of each instance of a metrics explorer blade and all of its configurations.

For grids in a particular JSON file, a particular attribute can include the Uniform Resource Locator (URL) to another JSON file, thus enabling multi-linking and re-use of individual JSON files by linking the JSON files together into a visualization web. The visualization web can be used to construct a web of visualization actions enabling data visualization exploration. Cross-domain support is provided so that JSON files from different users, different servers and/or different applications can co-exist in the visualization web. Multiple “favorites” (e.g., preferred or selected views) can be defined via JSON. One favorite can be selected as the definition URL for the selection action for any grid, enabling the building of user-specific JSON visualization hypertext webs without the need to write any code or JSON.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings:

FIG. 1a illustrates an example of a system 100 that includes a browser application configured to render pages from received JSON documents in accordance with aspects of the subject matter disclosed herein;

FIG. 1b illustrates an example of visualizations that a system such as system 100 may produce in accordance with aspects of the subject matter disclosed herein;

FIG. 1c illustrates another example of visualizations that a system such as system 100 may produce in accordance with aspects of the subject matter disclosed herein;

FIG. 2 illustrates an example of a method 200 for exploring metrics data using hypertext to visualize filtered data in accordance with aspects of the subject matter disclosed herein; and

FIG. 3 is a block diagram of an example of a computing environment in accordance with aspects of the subject matter disclosed herein.

### DETAILED DESCRIPTION

### Overview

The metrics explorer provides values, counts of events and measurements that occur when an application such as but not limited to a web application is miming. The metrics can help to detect performance issues and/or problems. The metrics can also help to detect trends in how the application is being used. Metrics and event counts can be displayed in visualizations such as graphs and/or charts of aggregated values. Aggregated values include sums, averages, counts and so on. When metrics explorer is initiated, a default view of data is provided. A large amount of data is typically provided. A subset of that data can be selected to narrow down the information displayed so that unselected information is filtered out. The subset can be identified by selecting a grid row or an element within a grid row. In response to receiving the selection, one or more filters can be applied to the data. The filters applied can be specific to the context. In response, another view of the data can be provided. The view provided can be another view of the same data or can be different data. This process can be repeated multiple times. The entire path of narrowing the data can be displayed in the visualization. This is useful because at the end of the process, a user can go back to any previous iteration and select a different grid row or grid element and pursue another narrowing process.

For example, suppose customers are complaining that a website is slow. Looking at general performance data from across the website may not be helpful in diagnosing that the problem actually exists in one page when viewed from a particular browser. The metrics explorer enables repeatedly drilling down into the information so that eventually the problem can be identified.

The data visualization metrics explorer can be implemented using a format such as but not limited to JavaScript Object Notation (JSON) and hypertext. When an element of a grid row is selected, a new metrics explorer blade can be opened (displayed). A filter can be applied so that only information associated with the selected element is presented. Additional filters may also be applied to the data that is displayed. Progressive, iterative filtering can occur. The links between blades can be specified using JSON and hypertext. The JSON file can define the content of each instance of a metrics explorer blade and all of its configurations.

For grids in a particular JSON file, a particular attribute can include the Uniform Resource Locator (URL) to another JSON file, thus enabling multi-linking and re-use of individual JSON files by linking the JSON files together into a web. The web of visualization can be used to construct a web of visualization actions enabling data visualization exploration. Cross-domain support is provided so that JSON files from different users, different servers and/or different applications can co-exist in the web. Multiple favorites can be defined via JSON. One favorite can be selected as the definition URL for the selection action for any grid, enabling the building of user-specific JSON visualization hypertext webs without the need to write any code or JSON. It will be appreciated that although the subject matter described herein is illustrated with respect to a metrics explorer the concepts described herein can be applied to any type of application.

### Visualization Hypertext

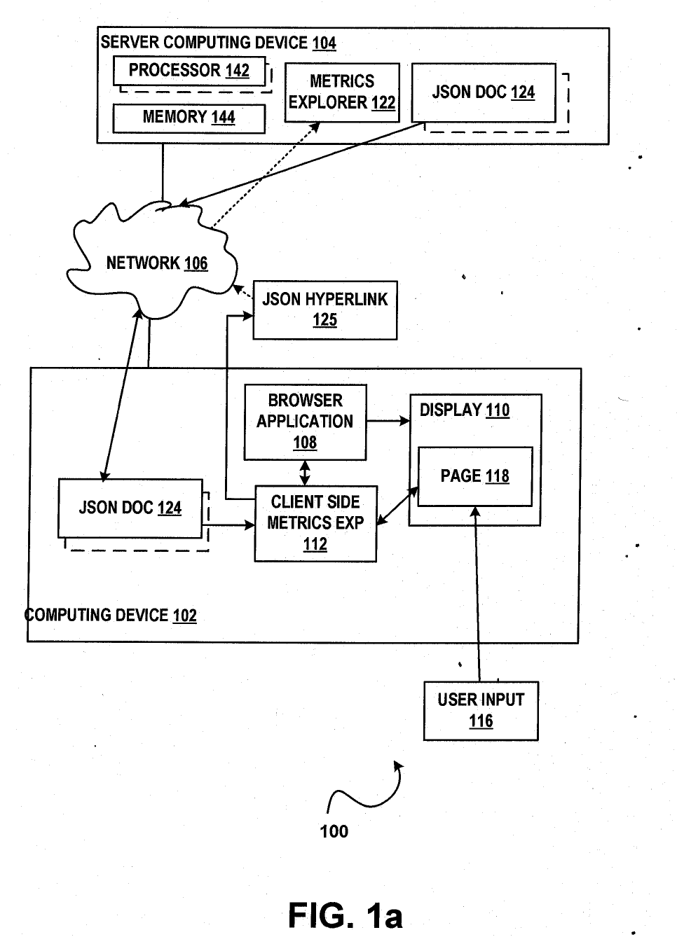

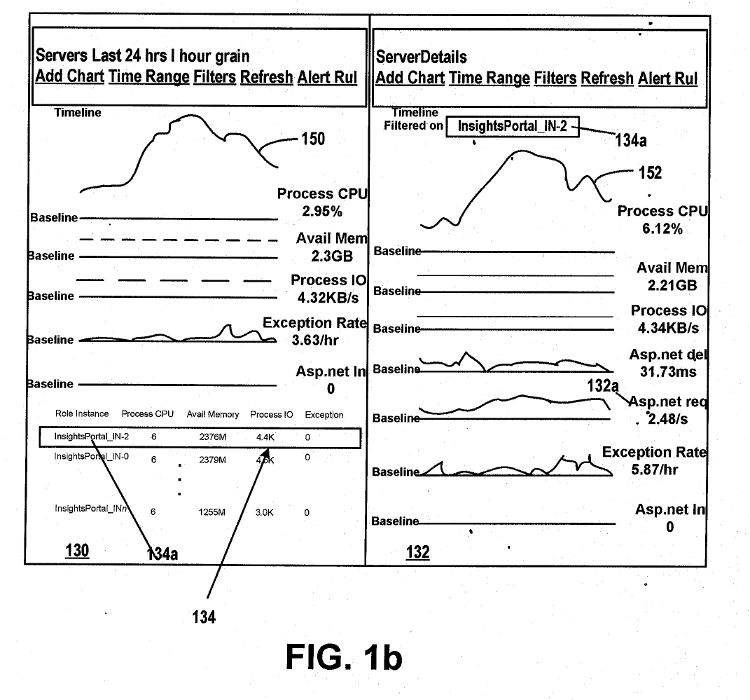

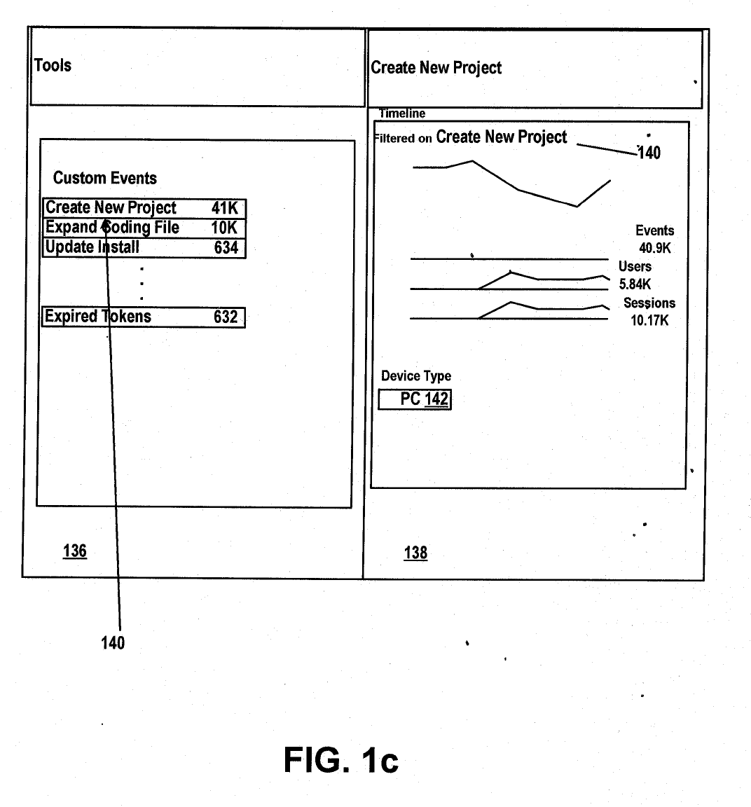

FIG. 1a illustrates a web browsing environment 100, in accordance with some aspects of the subject matter disclosed herein. As shown in FIG. 1a, environment 100 can include one or more of: a computing device 102, a server computing device 104, a network 106 and a browser application 108. Web browsing environment 100 may include other components known in the arts.

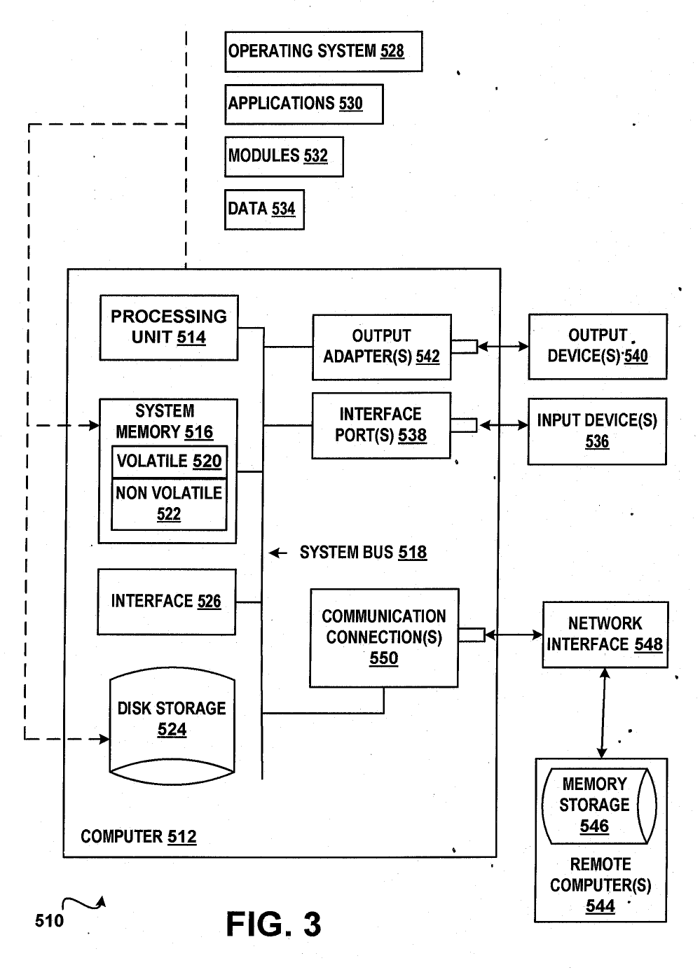

All or portions of system 100 may reside on one or more computers or computing devices such as the computers described below with respect to FIG. 3. Contemplated computing devices include but are not limited to desktop computers, tablet computers, laptop computers, notebook computers, personal digital assistants, smart phones, cellular telephones, mobile telephones, sensors, and so on. Thus, a computing device (e.g., computing device 102, server computing device 104, etc.) can be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a netbook, etc.), a mobile phone (e.g., a cell phone, a smart phone such as an Apple iPhone, a Google Android™ phone, a Microsoft Windows® phone, etc.), or other type of mobile device.

A computing device such as, for example, server computing device 104 can include one or more processors such as processor 142, etc., and a memory such as memory 144 that communicates with the one or more processors. A computing device such as computing device 102 similarly can include one or more processors (not shown) and a memory (not shown) that communicates with the one or more processors. Computing device 102 and server computing device 104 can be the same computing device. Computing device 102 and server computing device 104 can be different computing devices. Server computing device 104 may be implemented in one or more computer systems, including one or more servers, which may be any type of computing device described herein or otherwise known that is capable of enabling the corresponding functionality described herein.

System 100 or portions thereof may include information obtained from a service (e.g., in the cloud) or may operate in a cloud computing environment. A cloud computing environment can be an environment in which computing services are not owned but are provided on demand. For example, information may reside on multiple devices in a networked cloud and/or data can be stored on multiple devices within the cloud.

Computing device 102 and server computing device 104 can be communicatively coupled by network 106. Network 106 can include one or more communication links and/or communication networks, such as a PAN (personal area network), a LAN (local area network), a WAN (wide area network), or a combination of networks, such as the Internet. Computing device 102 and server 104 may be communicatively coupled to network 106 using various links, including wired and/or wireless links, such as IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB links, etc.

Server computing device 104 may include one or more program modules that when loaded into the memory 144 and accessed by the one or more processors such as processor 142, etc., cause the processor to perform the action or actions attributed to the one or more program modules. The one or more program modules (e.g., server-side metrics explorer 122) can, in response to receiving a request identifying a grid element for which additional information is desired, generate a metrics explorer blade for the identified grid element. A metrics explorer blade can be a visualization of data. A metrics explorer blade can be a user interface. Server-side metrics explorer can send the default metrics explorer blade to the requester (e.g., computing device 102). In response to receiving a selection from within the provided metrics explorer blade, the selection identifying a particular grid element within the provided blade, the server-side metrics explorer 122 can generate another metrics explorer blade. This metrics explorer blade can be sent to the requestor. This process can be repeated multiple times. Each time the process is repeated, another hyperlink (e.g., JSON hyperlink 125) can be received from the client and another document (e.g., JSON document 124) can be fetched by the server and provided to the client. The filtering context from the previous blade can also be provided to any depth or level.

Computing device 102 may include one or more client-side metrics explorer program modules that when loaded into the memory (not shown) and accessed by the one or more processors (not shown), etc., cause the processor to perform the action or actions attributed to the one or more program modules. For example, the one or more program modules (e.g., client-side metrics explorer 112) can, in response to receiving user input such as user input 116, generate a JSON hyperlink 125 requesting additional information for an identified grid element. Client-side metrics explorer 112 can receive in response, a JSON document 124 from server computing device 104 comprising additional information for the identified grid element.

Browser 108 can be a program that can execute on computing device 102. Browser 108 can enable network information resources to be retrieved, presented, and traversed. An information resource or object can be retrieved by browser 108 using a network address, such as a uniform resource identifier (URI). Examples of information resources include web pages, images, videos, and other forms of content. Hyperlinks that are present in information resources enable navigation to resources. Examples of browsers include but are not limited to Internet Explorer®, developed by Microsoft Corp. of Redmond, Wash., Mozilla Firefox®, developed by Mozilla Corp. of Mountain View, Calif., Safari®, developed by Apple Inc. of Cupertino, Calif., and Google® Chrome of Mountain View, Calif.

In accordance with aspects of the subject matter described herein, browser 108 can retrieve a document from a server computing device 104 through network 106. The document can be a web document. The document can be a JSON document such as JSON document 124. Alternatively, the document can be a text document, XML, etc.

The client-side metrics explorer program module 112 (“metrics explorer”) can instruct browser application 108 to manipulate data and/or can instruct browser application 108 as to how to render the data (e.g., by manipulating the DOM and/or interacting with other scripts that manipulate the DOM on behalf of the metrics explorer scripts). Browser application 108 can render the DOM to the user in the form of the metrics explorer user interface. The metrics explorer scripts can react to browser events that are fired in response to user input. Such events can occur when a user clicks on a grid row/element and in response, the metrics explorer can read the document such as but not limited to a JSON document to determine the next URL (representing the next document) to download. In other words, an attribute of a grid defined in a document can be a URL. A client-side metrics explorer application can include a program module that formats information (e.g., from JSON document 124), and displays the formatted information. For example, as shown in FIG. 1a, browser application 108 can generate a page 118 based on a document such as JSON document 124 that is displayed on a display 110 of computing device 102. Browser application 108 can be configured to execute one or more scripts that are embedded in the document (e.g., a JSON document such as JSON document 124), or that are separate from but associated with the document.

FIG. 1b illustrates an example of visualizations that a system such as system 100 may produce in accordance with aspects of the subject matter disclosed herein. FIG. 1b illustrates a first visualization, visualization 130 and a second visualization 132 but it will be appreciated that additional visualizations may also be displayed. In visualization 130 a grid row, grid row 134 has been selected. In this case, a grid row corresponds to one server of n servers. In response a document was fetched and/or was generated by the server, sent to the client, and displayed at the client as visualization 132. Visualization 132 can display the same or similar information for the selected server. Visualization 132 can display the additional information for the selected server. Thus, it will be appreciated that the information displayed in visualization 132 represents a narrowing down of the information displayed in visualization 130 although additional information may also be displayed. In other words, a filter or filters associated with one visualization can be inherited by a subsequent visualization. For example, whereas visualization 130 displays Process CPU 150 information for n servers, visualization 132 displays Process CPU 152 information only for server InsightPortal_IN_2. Moreover, delivery of Asp.net information 132a is displayed for InsightsPortal_IN_2 server 134a in visualization 132a but this type of information is not displayed in visualization 130.

FIG. 1c illustrates another example of visualizations that a system such as system 100 may produce in accordance with aspects of the subject matter disclosed herein. FIG. 1c illustrates a first visualization, visualization 136 and a second visualization 138. In visualization 136 a grid row, grid row 140 representing “Create New Project” has been selected. In response a document was fetched and/or generated by the server, sent to the client, and displayed at the client as visualization 138. Visualization 138 provides information about the events users and sessions for the new project. The process can be repeated. For example, selecting the grid row element 142 (for PCs) would result in information that was related to both the grid row element 142 and the grid row 140 (both to create new projects and for PCs) to be generated and displayed. Thus, the built-up context for this selection filters data so that only data that is related to the selected element PCs for the previously selected element Create new project is displayed. The built-up context can include context for multiple levels of selections because selection can continue to any suitable depth or level.

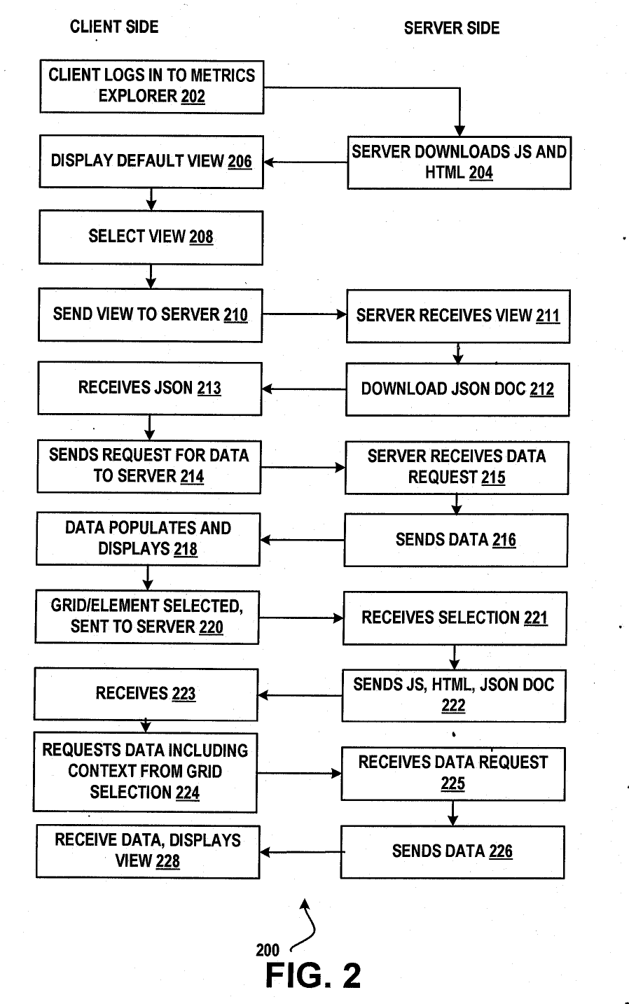

FIG. 2 illustrates an example of a method 200 for exploration of metrics information using hypertext in accordance with aspects of the subject matter disclosed herein. The method described in FIG. 2 can be practiced by a system such as but not limited to the one described with respect to FIG. 1a. While method 200 describes a series of operations that are performed in a sequence, it is to be understood that method 200 is not limited by the order of the sequence depicted. For instance, some operations may occur in a different order than that described. In addition, one operation may occur concurrently with another operation. In some instances, not all operations described are performed. In some instances, not all operations performed are illustrated.

At operation 202 a client can request to log in to the metrics explorer. At operation 204 in response to a successful log in attempt, the server can download to the client device the JavaScript and HTML needed to render on the client device a default view of the metrics explorer. At operation 206, on the client device, the default view of the metrics explorer can be displayed. At operation 208, a selection of a desired view can be made. At operation 210 the selection can be sent to the server. At operation 211 the server can receive the selection. At operation 212 the server can download to the client a document such as a JSON document associated with the selected view. At operation 213 the client can receive the JSON file and can execute it. At operation 214 the client can send a request to the server for the data to populate the view (extracted from the JSON document). At operation 215 the server can receive the request for the data. At operation 216 the server can send the data to the client device.

At operation 218 the view can be populated and displayed. At operation 220 an element of a grid row or a grid row can be selected. At operation 220 selection of a grid row or element of a grid row can trigger a request for additional JavaScript, HTML and a JSON document to be sent to the server. At operation 221 the server can receive the selection and at operation 222 the server can download to the client the JavaScript, HTML and a JSON document associated with the selected grid row or element of a grid row. At operation 223 the client can receive the JavaScript, HTML and JSON document. At operation 224 the client can request data from the server and can pass along the context from the grid row or element selection. The client can send the context to the server in the form of filters applied to the data queries. At operation 225 the server can receive the data request and can apply the context to the data set. At operation 226 the server can send the data. At operation 228 the data can be used to populate the view on the client machine. Operations 220 through 226 can be repeated multiple times. At the end of the exploration, a search can be conducted to return properties of the isolated result (not shown).

### Example of a Suitable Computing Environment

In order to provide context for various aspects of the subject matter disclosed herein, FIG. 3 and the following discussion are intended to provide a brief general description of a suitable computing environment 510 in which various embodiments of the subject matter disclosed herein may be implemented. While the subject matter disclosed herein is described in the general context of computer-executable instructions, such as program modules, executed by one or more computers or other computing devices, those skilled in the art will recognize that portions of the subject matter disclosed herein can also be implemented in combination with other program modules and/or a combination of hardware and software. Generally, program modules include routines, programs, objects, physical artifacts, data structures, etc. that perform particular tasks or implement particular data types. Typically, the functionality of the program modules may be combined or distributed as desired in various embodiments. The computing environment 510 is only one example of a suitable operating environment and is not intended to limit the scope of use or functionality of the subject matter disclosed herein.

With reference to FIG. 3, a computing device in the form of a computer 512 is described. Computer 512 may include at least one processing unit 514, a system memory 516, and a system bus 518. The at least one processing unit 514 can execute instructions that are stored in a memory such as but not limited to system memory 516. The processing unit 514 can be any of various available processors. For example, the processing unit 514 can be a graphics processing unit (GPU). The instructions can be instructions for implementing functionality carried out by one or more components or modules discussed above or instructions for implementing one or more of the methods described above. Dual microprocessors and other multiprocessor architectures also can be employed as the processing unit 514. The computer 512 may be used in a system that supports rendering graphics on a display screen. In another example, at least a portion of the computing device can be used in a system that comprises a graphical processing unit. The system memory 516 may include volatile memory 520 and nonvolatile memory 522. Nonvolatile memory 522 can include read only memory (ROM), programmable ROM (PROM), electrically programmable ROM (EPROM) or flash memory. Volatile memory 520 may include random access memory (RAM) which may act as external cache memory. The system bus 518 couples system physical artifacts including the system memory 516 to the processing unit 514. The system bus 518 can be any of several types including a memory bus, memory controller, peripheral bus, external bus, or local bus and may use any variety of available bus architectures. Computer 512 may include a data store accessible by the processing unit 514 by way of the system bus 518. The data store may include executable instructions, 3D models, materials, textures and so on for graphics rendering.

Computer 512 typically includes a variety of computer readable media such as volatile and nonvolatile media, removable and non-removable media. Computer readable media may be implemented in any method or technology for storage of information such as computer readable instructions, data structures, program modules or other data. Computer readable media include computer-readable storage media (also referred to as computer storage media) and communications media. Computer storage media includes physical (tangible) media, such as but not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices that can store the desired data and which can be accessed by computer 512. Communications media include media such as, but not limited to, communications signals, modulated carrier waves or any other intangible media which can be used to communicate the desired information and which can be accessed by computer 512.

It will be appreciated that FIG. 3 describes software that can act as an intermediary between users and computer resources. This software may include an operating system 528 which can be stored on disk storage 524, and which can allocate resources of the computer 512. Disk storage 524 may be a hard disk drive connected to the system bus 518 through a non-removable memory interface such as interface 526. System applications 530 take advantage of the management of resources by operating system 528 through program modules 532 and program data 534 stored either in system memory 516 or on disk storage 524. It will be appreciated that computers can be implemented with various operating systems or combinations of operating systems.

A user can enter commands or information into the computer 512 through an input device(s) 536. Input devices 536 include but are not limited to a pointing device such as a mouse, trackball, stylus, touch pad, keyboard, microphone, voice recognition and gesture recognition systems and the like. These and other input devices connect to the processing unit 514 through the system bus 518 via interface port(s) 538. An interface port(s) 538 may represent a serial port, parallel port, universal serial bus (USB) and the like. Output devices(s) 540 may use the same type of ports as do the input devices. Output adapter 542 is provided to illustrate that there are some output devices 540 like monitors, speakers and printers that require particular adapters. Output adapters 542 include but are not limited to video and sound cards that provide a connection between the output device 540 and the system bus 518. Other devices and/or systems or devices such as remote computer(s) 544 may provide both input and output capabilities.

Computer 512 can operate in a networked environment using logical connections to one or more remote computers, such as a remote computer(s) 544. The remote computer 544 can be a personal computer, a server, a router, a network PC, a peer device or other common network node, and typically includes many or all of the elements described above relative to the computer 512, although only a memory storage device 546 has been illustrated in FIG. 3. Remote computer(s) 544 can be logically connected via communication connection(s) 550. Network interface 548 encompasses communication networks such as local area networks (LANs) and wide area networks (WANs) but may also include other networks. Communication connection(s) 550 refers to the hardware/software employed to connect the network interface 548 to the bus 518. Communication connection(s) 550 may be internal to or external to computer 512 and include internal and external technologies such as modems (telephone, cable, DSL and wireless) and ISDN adapters, Ethernet cards and so on.

It will be appreciated that the network connections shown are examples only and other means of establishing a communications link between the computers may be used. One of ordinary skill in the art can appreciate that a computer 512 or other client device can be deployed as part of a computer network. In this regard, the subject matter disclosed herein may pertain to any computer system having any number of memory or storage units, and any number of applications and processes occurring across any number of storage units or volumes. Aspects of the subject matter disclosed herein may apply to an environment with server computers and client computers deployed in a network environment, having remote or local storage. Aspects of the subject matter disclosed herein may also apply to a standalone computing device, having programming language functionality, interpretation and execution capabilities.

The various techniques described herein may be implemented in connection with hardware or software or, where appropriate, with a combination of both. Thus, the methods and apparatus described herein, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing aspects of the subject matter disclosed herein. As used herein, the term “machine-readable medium” shall be taken to exclude any mechanism that provides (i.e., stores and/or transmits) any form of propagated signals. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects, e.g., through the use of a data processing API or the like, may be implemented in a high level procedural or object oriented programming language to communicate with a computer system. However, the program(s) can be implemented in assembly or machine language, if desired. In any case, the language may be a compiled or interpreted language, and combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A system comprising:
at least one processor:
a memory connected to the at least one processor; and
at least one program module that when loaded into the memory causes the at least one processor to:
use progressive, iterative filtering to provide metrics information for an application; and
using hypertext and at least one document to link together visualizations of the metrics information.

2. The system of claim 1, further comprising:
at least one program module that when loaded into the memory causes the at least one processor to:
in response to receiving a selected view, download the at least one document associated with the downloaded view.

3. The system of claim 1, further comprising at least one program module that when loaded into the memory causes the at least one processor to:
send data to populate a visualization, the data defined by the at least one document associated with the visualization.

4. The system of claim 1, further comprising at least one program module that when loaded into the memory causes the at least one processor to:
apply a first filter associated with a first visualization to filter out unselected information from the first visualization and apply the first filter and a second filter, the second filter associated with a second visualization, the second visualization comprising information for a selection from the first visualization.

5. The system of claim 1, further comprising at least one program module that when loaded into the memory causes the at least one processor to:
apply a filter to filter out information not associated with a selection comprising a grid row.

6. The system of claim 5, further comprising at least one program module that when loaded into the memory causes the at least one processor to:
in response to receiving the selected grid row, download a JSON document associated with the selected grid row.

7. The system of claim 1, in response to receiving a selected element of a grid row, download a JSON document associated with the selected element of the grid row.

8. A method comprising:
performing by at least one processor of a computing device comprising a client computing device:
iteratively filtering metrics associated with program execution by repeatedly performing the following operations:
selecting an element of a visualization of a metrics explorer;
receiving a file associated with the selected element;
receiving data defined in the file; and
displaying the data in a visualization.

9. The method of claim 8, wherein the element is a grid row.

10. The method of claim 8, wherein the element is an element of a grid row.

11. The method of claim 8, wherein links between visualizations are specified using JSON and hypertext.

12. The method of claim 11, wherein an attribute of a grid defined in a JSON document is a URL.

13. The method of claim 8, wherein filters from a first visualization are inherited by a second visualization.

14. A system comprising:
at least one processor:
a memory connected to the at least one processor of a computing node; and
at least one program module that when loaded into the memory causes the at least one processor to:
link visualizations of a metrics explorer using at least one document comprising hypertext.

15. The system of claim 14, further comprising
at least one program module that when loaded into the memory causes the at least one processor to:
inherit a first filter associated with a first visualization by a second visualization.

16. The system of claim 14, further comprising
at least one program module that when loaded into the memory causes the at least one processor to:
receive a selection comprising a grid row, and in response identifying at least one document associated with the selection.

17. The system of claim 14, further comprising
at least one program module that when loaded into the memory causes the at least one processor to:
receive a selection comprising a view; and
in response, to identify a document associated with the view.

18. The system of claim 14, further comprising
at least one program module that when loaded into the memory causes the at least one processor to:
receive a selection comprising an element of a grid row; and
in response to identify at least one document associated with the selection.

19. The system of claim 14, further comprising
at least one program module that when loaded into the memory causes the at least one processor to:
determine data associated with a visualization from at least one document associated with the visualization;
request the data; and
in response to receiving the requested data, populate the visualization with the data.

20. The system of claim 14, further comprising
wherein the at least one document is a JSON document.
